(19) United States
(12) Patent Application Publication
(10) Pub. No.: US 2025/0200695 A1
(43) Pub. Date: Jun. 19, 2025

(54) APPARATUS AND METHOD FOR 3-DIMENSIONAL PARALLELIZATION FOR HETEROGENEOUS GPU CLUSTER

(71) Applicant: Electronics and Telecommunications Research Institute, Daejeon (KR)

(72) Inventors: Baik-Song AN, Seoul (KR); Ki-Dong KANG, Daejeon (KR); Hong-Yeon KIM, Daejeon (KR); Myung-Hoon CHA, Daejeon (KR)

(73) Assignee: Electronics and Telecommunications Research Institute, Daejeon (KR)

(21) Appl. No.: 18/978,270

(22) Filed: Dec. 12, 2024

(30) Foreign Application Priority Data
Dec. 13, 2023 (KR) 10-2023-0180525

(51) Int. Cl. G06T 1/20; G06T 15/00

(52) U.S. Cl. CPC G06T 1/20; G06T 15/005; G06T 2210/52

(57) ABSTRACT

Disclosed herein is an apparatus and method for 3D parallelization for a heterogeneous GPU cluster. The method may include generating initialization information based on GPU memory capacity in order to parallelize a model across multiple nodes constituting a heterogeneous GPU cluster, pipeline-parallelizing the model based on the multiple nodes using the generated initialization information, and data/tensor-parallelizing layers of the model, which are allocated to each of the multiple nodes according to pipeline parallelization, based on GPUs mounted in the corresponding node.

### CROSS REFERENCE TO RELATED APPLICATION

This application claims the benefit of Korean Patent Application No. 10-2023-0180525, filed Dec. 13, 2023, which is hereby incorporated by reference in its entirety into this application.

### BACKGROUND OF THE INVENTION

### 1. Technical Field

The disclosed embodiment relates to technology for 3D parallel training and inference using a large model.

### 2. Description of the Related Art

With the recent explosion of Artificial Intelligence (AI) and deep-learning technology, the required levels of the accuracy and performance of AI are also rapidly increasing. Accordingly, the scale of AI models is also exponentially increasing, and the trend is outpacing the advancement of related hardware.

The computation and memory amounts required for currently widely used large-scale models have significantly increased more than a single Graphics Processing Unit (GPU) can handle. As a result, in order to perform training and service using a large-scale AI model, there is no choice but to use a method of performing parallel training and inference by clustering multiple server nodes including multiple GPUs installed therein and distributing the model using the cluster.

The currently used main parallelism techniques include data parallelism, tensor parallelism, and pipeline parallelism techniques, and using a combination of these three techniques is commonly referred to as 3-dimensional (3D) parallelism. Parallelization requires consideration of the specification of the hardware platform to run a model, but most of the previous parallelism techniques require users to determine a parallelism policy by themselves, which greatly harms the usability.

As a result, an automatic parallelism technique for automatically determining a parallelism policy optimized for a given hardware platform has emerged. However, because a task of automatically performing parallelization in consideration of various models and hardware platform specifications is very complicated, most existing automatic parallelism techniques assume homogeneous hardware platforms in which hardware, such as GPUs, networks, etc., has the same specifications, thereby reducing the complexity.

However, GPU servers used for deep learning are very expensive to build, so it may be difficult to introduce all devices at once, and it may be necessary to gradually build additional servers over time. In this case, hardware specifications will inevitably differ between the existing devices and the newly built devices.

This problem may occur not only on-premises but also in a cloud platform. The cost of renting GPU servers in a cloud is also very high, and when it is difficult to build a homogeneous cluster with only GPU servers of the desired specification due to the cost, a heterogeneous cluster that uses GPU servers of a lower specification together with the GPU servers of the desired specification may be built, whereby the cost may be reduced. However, the heterogeneity between the servers makes it impossible to use the existing automatic parallelism techniques.

Therefore, what is required is a new efficient automatic parallelism technique that supports a heterogeneous cluster and has low complexity.

Also, the most important reason for model parallelism is that a model is required to be split due to insufficient GPU memory, and the need of a technique capable of recognizing nodes having different GPU memory sizes and efficiently searching for a parallelism policy optimized therefor is growing.

### SUMMARY OF THE INVENTION

An object of the disclosed embodiment is to automatically determine a 3D parallelization policy for training and inference using a large model in a heterogeneous GPU cluster system where GPUs with different performance are mounted in respective nodes.

An apparatus for 3D parallelization for a heterogeneous GPU cluster according to an embodiment includes memory in which at least one program is recorded and a processor for executing the program. The program may generate initialization information based on GPU memory capacity in order to parallelize a model across multiple nodes constituting a heterogeneous GPU cluster, pipeline-parallelize the model based on the multiple nodes using the generated initialization information, and data/tensor-parallelize layers of the model, which are allocated to each of the multiple nodes according to pipeline parallelization, based on GPUs mounted in the corresponding node.

Here, the multiple nodes may include an equal number of GPUs mounted therein, and the number of GPUs may a power of 2.

Here, when generating the initialization information, the program may arrange the multiple nodes based on the total amount of GPU memory, set a node sequence in the order in which the multiple nodes are arranged, and calculate the amount of GPU memory required for each of the layers constituting the model.

Here, the node sequence may be a sequence of the nodes arranged in ascending order of the total amount of GPU memory.

Here, when pipeline-parallelizing the model, the program may divide the layers constituting the model into equal numbers and initially allocate the layers to the multiple nodes according to the node sequence, and when there is a node to which layers having a memory requirement greater than the total amount of GPU memory of the node are allocated, the program may reallocate part of the layers of the corresponding node to another node.

Here, when reallocating the part of the layers, the program may transfer remaining layers, excluding layers having a memory requirement satisfied by the total amount of GPU memory of the corresponding node, to a node at the subsequent position in the node sequence.

Here, when reallocating the part of the layers, the program may calculate the memory requirement of a node receiving layers from a node at the previous position in the node sequence by including the initially allocated layers and the received layers.

Here, when data/tensor-parallelizing the layers, the program may initially calculate a tensor parallelism degree and a data parallelism degree for each of the nodes and set a final tensor parallelism degree and a final data parallelism degree by aggregating values initially calculated for the respective nodes.

Here, when initially calculating the tensor parallelism degree and the data parallelism degree, the program may calculate the tensor parallelism degree based on the memory requirement of the allocated model layers and memory capacity of a single GPU and calculate the data parallelism degree based on the calculated tensor parallelism degree and the number of GPUs.

Here, when setting the final tensor parallelism degree and the final data parallelism degree, the program may set the final tensor parallelism degree to a maximum value of the tensor parallelism degrees initially calculated for the respective nodes and set the final data parallelism degree to the initial data parallelism degree of a node that has the final tensor parallelism degree as the initial tensor parallelism degree thereof.

A method for 3D parallelization for a heterogeneous GPU cluster according to an embodiment may include generating initialization information based on GPU memory capacity in order to parallelize a model across multiple nodes constituting a heterogeneous GPU cluster, pipeline-parallelizing the model based on the multiple nodes using the generated initialization information, and data/tensor-parallelizing layers of the model, which are allocated to each of the multiple nodes according to pipeline parallelization, based on GPUs mounted in the corresponding node.

Here, generating the initialization information may include arranging the multiple nodes based on the total amount of GPU memory, setting a node sequence in the order in which the multiple nodes are arranged, and calculating the amount of GPU memory required for each of the layers constituting the model.

Here, the node sequence may be a sequence of the nodes arranged in ascending order of the total amount of GPU memory.

Here, pipeline-parallelizing the model may include dividing the layers constituting the model into equal numbers and initially allocating the layers to the multiple nodes according to the node sequence; and, when there is a node to which layers having a memory requirement greater than the total amount of GPU memory of the node are allocated, reallocating part of the layers of the corresponding node to another node.

Here, reallocating the part of the layers may comprise transferring remaining layers, excluding layers having a memory requirement satisfied by the total amount of GPU memory of the corresponding node, to a node at the subsequent position in the node sequence.

Here, reallocating the part of the layers may comprise calculating a memory requirement of a node receiving layers from a node at the previous position in the node sequence by including the initially allocated layers and the received layers.

Here, data/tensor-parallelizing the layers may include initially calculating a tensor parallelism degree and a data parallelism degree for each of the nodes and setting a final tensor parallelism degree and a final data parallelism degree by aggregating values initially calculated for the respective nodes.

Here, initially calculating the tensor parallelism degree and the data parallelism degree may include calculating the tensor parallelism degree based on the memory requirement of the allocated model layers and memory capacity of a single GPU and calculating the data parallelism degree based on the calculated tensor parallelism degree and the number of GPUs.

Here, setting the final tensor parallelism degree and the final data parallelism degree may include setting the final tensor parallelism degree to a maximum value of the tensor parallelism degrees initially calculated for the respective nodes and setting the final data parallelism degree to the initial data parallelism degree of a node that has the final tensor parallelism degree as the initial tensor parallelism degree thereof.

A method for 3D parallelization for a heterogeneous GPU cluster according to an embodiment may include arranging multiple nodes in ascending order of the total amount of GPU memory; setting a node sequence in the order in which the multiple nodes are arranged; calculating the amount of GPU memory required for each of layers constituting a model; dividing the layers constituting the model into equal numbers and initially allocating the layers to the multiple nodes according to the node sequence; when there is a node to which layers having a memory requirement greater than the total amount of GPU memory of the node are allocated, reallocating part of the layers of the corresponding node to another node; initially calculating a tensor parallelism degree and a data parallelism degree for each of the nodes; and setting a final tensor parallelism degree and a final data parallelism degree by aggregating values initially calculated for the respective nodes.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic structure diagram of a heterogeneous GPU cluster system to which an embodiment is applied;

FIG. 2 is a configuration diagram of a framework including a parallelizing module according to an embodiment;

FIG. 3 is a configuration diagram of a framework including a parallelizing module according to another embodiment;

FIG. 4 is a schematic block diagram of a parallelizing module according to an embodiment;

FIG. 5 is a flowchart for explaining the operation of an initializing module according to an embodiment;

FIG. 6 is a flowchart for explaining the operation of a pipeline parallelizing module according to an embodiment;

FIGS. 7 and 8 are views illustrating an example of pipeline parallelization according to an embodiment;

FIG. 9 is a view illustrating another example of pipeline parallelization according to an embodiment;

FIG. 10 is a flowchart for explaining the operation of a data/tensor parallelizing module according to an embodiment;

FIG. 11 is a flowchart for explaining the operation of a data/tensor parallelizing module for each node according to an embodiment;

FIG. 12 is a view illustrating an example of data/tensor parallelization according to an embodiment;

FIG. 13 is a view illustrating another example of data/tensor parallelization according to an embodiment; and

FIG. 14 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

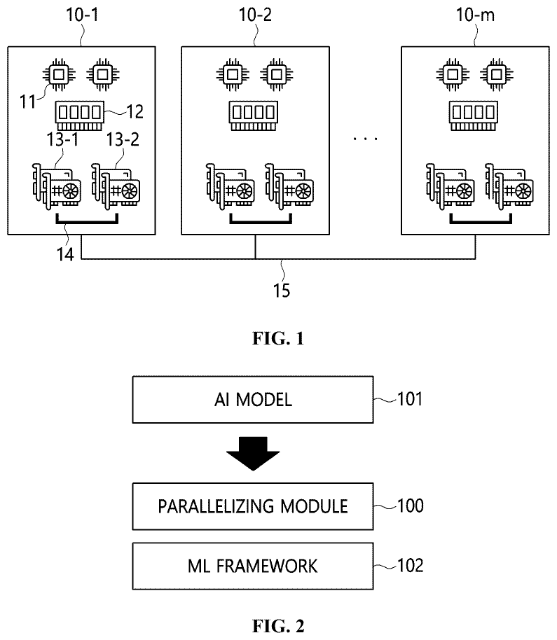

FIG. 1 is a schematic structure diagram of a heterogeneous GPU cluster system to which an embodiment is applied.

Referring to FIG. 1, the heterogeneous GPU cluster system may be configured such that multiple nodes 10-1, 10-2, . . . , 10-m are connected to each other through external interconnect (InfiniBand, 10 Gigabit Ethernet (GbE), etc.) 15.

According to an embodiment, the interconnect topology between all of the nodes 10-1, 10-2, . . . , 10-m in the cluster may be symmetric.

That is, the network performance between all of the nodes 10-1, 10-2, . . . , 10-m is the same. This is a naturally satisfied condition because a typical rack-scale GPU cluster has a structure in which it is connected to the same top-of-rack (ToR) switch.

Each of the multiple nodes 10-1, 10-2, . . . , 10-m may include a general-purpose CPU 11 on which at least one core is mounted, system memory 12, and multiple GPUs 13-1 and 13-2.

Here, the multiple GPUs 13-1 and 13-2 may be connected to each other through internal interconnect (Peripheral Component Interconnect Express (PCIe), NVLink, etc.).

Here, the performance of the internal interconnect may be superior to that of the external interconnect in terms of both latency and bandwidth. This is the condition satisfied by most existing GPU servers.

According to an embodiment, the multiple GPUs 13-1 and 13-2 mounted in a single node may have the same performance. This is because a GPU cluster is generally expanded by adding a node, in which case GPUs of the same type are generally mounted in the node.

According to an embodiment, the multiple nodes 10-1, 10-2, . . . , 10-m may have an equal number of GPUs mounted therein, and the number of GPUs may be a power of 2.

A framework including an apparatus 100 for 3D parallelization of a large model (referred to as a ‘parallelizing module’ hereinbelow) may have various embodiments through the heterogeneous GPU cluster system described above.

FIG. 2 is a configuration diagram of a framework including a parallelizing module according to an embodiment.

Referring to FIG. 2, the parallelizing module 100 according to an embodiment has a structure in which it is present as an upper-level module of a machine-learning (ML) framework (TensorFlow, PyTorch, etc.) 102.

That is, the parallelizing module 100 receives AI model code 101 written by a user, parallelizes the same, and transfers the parallelized model to the lower framework 102.

Accordingly, the framework 102 performs actual training or inference based on the parallelized model.

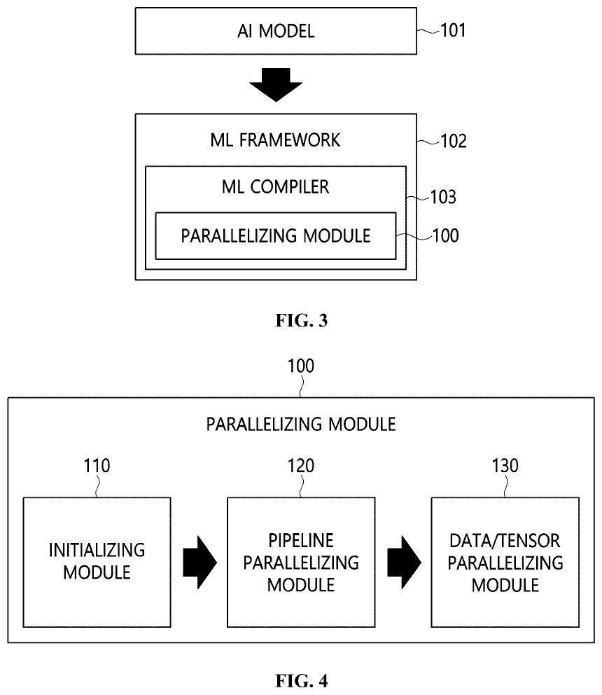

FIG. 3 is a configuration diagram of a framework including a parallelizing module according to another embodiment.

Referring to FIG. 3, the parallelizing module 100 according to another embodiment has a structure in which it is present as an internal module of a machine-learning (ML) framework (TensorFlow, PyTorch, etc.) 102.

That is, when a machine-learning model compiler 103 is present in the machine-learning framework 102, the parallelizing module 100 may be placed in the compiler 103.

The machine-learning framework 102 directly processes a model 101 input by a user and performs a compilation operation, and the parallelizing module 100 interferes in the compilation operation, thereby performing parallelization.

FIG. 4 is a schematic block diagram of a parallelizing module according to an embodiment.

Referring to FIG. 4, the parallelizing module 100 according to an embodiment may include an initializing module 110, a pipeline parallelizing module 120, and a data/tensor parallelizing module 130.

The initializing module 110 generates initialization information based on GPU memory capacity in order to parallelize a model across multiple nodes that constitute a heterogeneous GPU cluster.

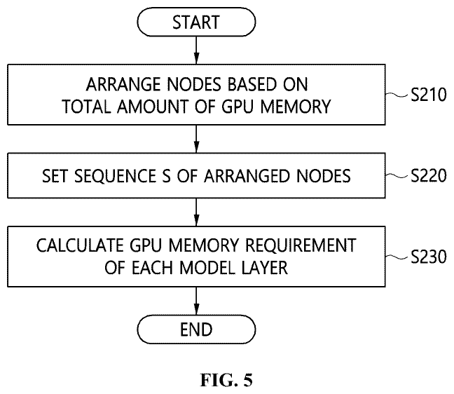

That is, the total amount of GPU memory of each node and the amount of GPU memory required for each model layer are calculated in advance for parallelization. The detailed operation of the initializing module 110 will be described later with reference to FIG. 5.

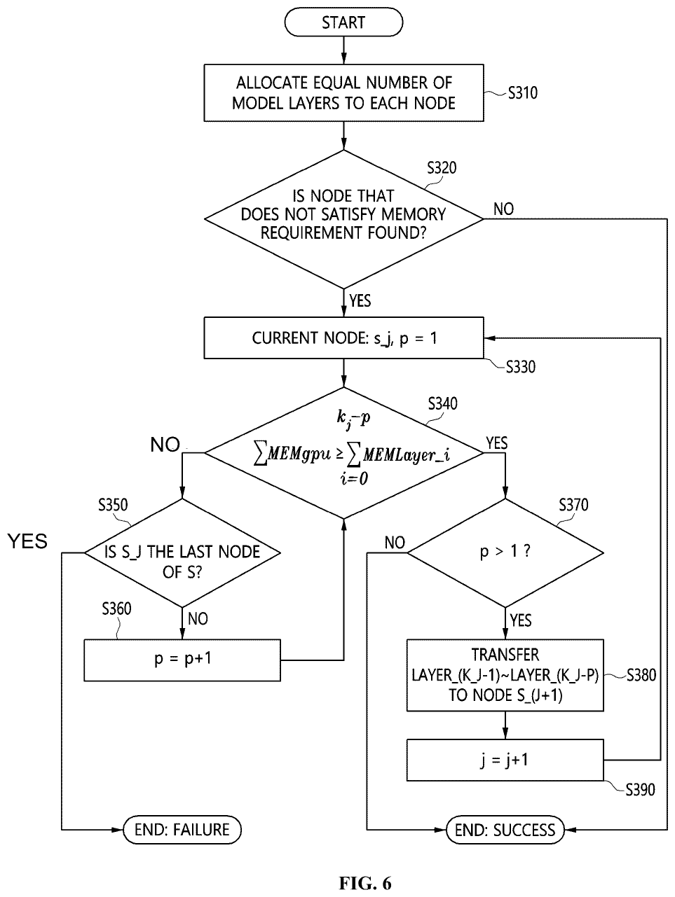

Using the generated initialization information, the pipeline parallelizing module 120 pipeline-parallelizes the model based on the multiple nodes. The detailed operation of the pipeline parallelizing module 120 will be described with reference to FIGS. 6 to 9.

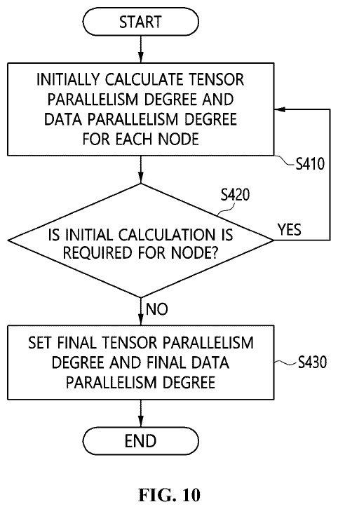

The data/tensor parallelizing module 130 data/tensor-parallelizes model layers, which are allocated to each the multiple nodes according to pipeline parallelization, based on the GPUs mounted in the corresponding node. The detailed operation of the data/tensor parallelizing module 130 will be described with reference to FIGS. 10 to 13.

According to an embodiment, pipeline parallelization may be applied between nodes, and data/tensor parallelization may be applied in a single node, as described above.

This is because the performance of the external interconnect for connecting the nodes is lower than the performance of the internal interconnect in the node, as described above. This is for utilizing the external interconnect for pipeline parallelization, which has relatively low network load.

Also, it is good to maximize the parallelization of data within the node as much as possible in order to process as much training data as possible at the same time, but it may be desirable to use tensor parallelization together at the minimum level possible due to the burden of GPU memory.

FIG. 5 is a flowchart for explaining the operation of an initializing module according to an embodiment.

Referring to FIG. 5, the initializing module 110 arranges multiple nodes 10-1, 10-2, . . . , 10-m based on the total amount of GPU memory included in each of the multiple nodes at step S210.

Here, assuming that m nodes constitute a cluster and that the nodes are assigned unique identifiers from 0 to (m−1), the total amount of GPU memory mounted in a specific node i (i=0, . . . , m−1) is expressed as MEM_{gpu_i}.

Here, the nodes may be arranged in ascending order of the total amount of memory MEM_{gpu_i}.

Subsequently, the initializing module 110 sets a node sequence S according to the order of the arranged nodes at step S220.

Here, the node sequence S may be defined as shown in Equation (1) below:

$$S = ( s\_ 0 , s\_ 1 , … , s\_ ( m - 1 ) ) \qquad ( 1 )$$

$${MEM}_{gpu \_ s \_ i} <= {MEM}_{gpu \_ s \_ ( i + 1 )} , 0 <= i < ( m - 1 )$$

Generally, because a hardware specification of a GPU cluster is not dynamically changed, it is not necessary to repeatedly set the node sequence S each time parallelization is performed. That is, once the node sequence S is set, it is stored in a separate space, and it may be updated through the initialization task only when the hardware specification of the cluster is changed. Accordingly, the repetitive task may be skipped.

Subsequently, the initializing module 110 calculates the amount of GPU memory required for each of the layers constituting the model at step S230.

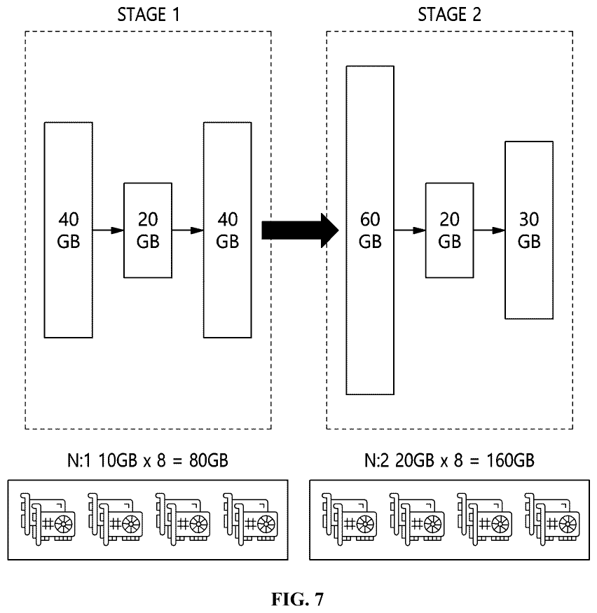

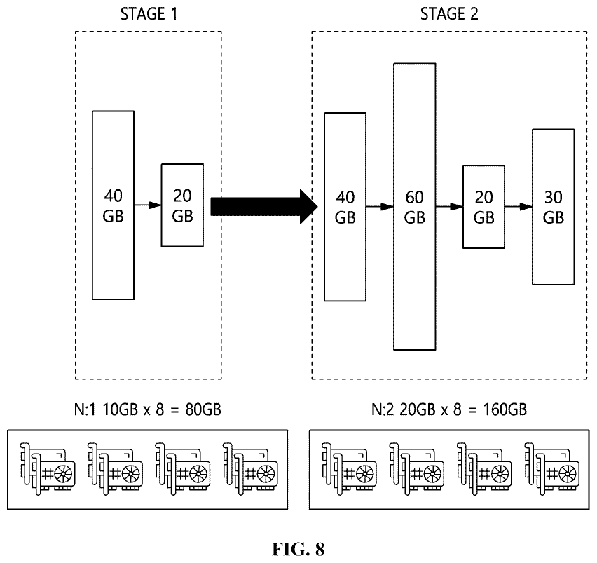

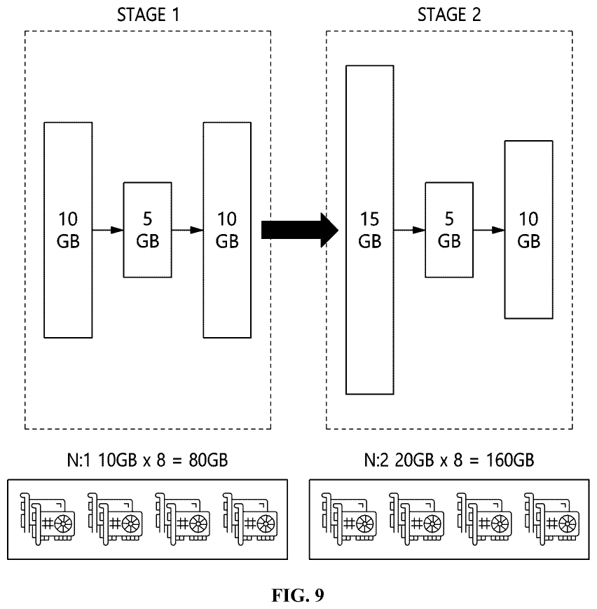

FIG. 6 is a flowchart for explaining the operation of a pipeline parallelizing module according to an embodiment, FIGS. 7 and 8 are views illustrating an example of pipeline parallelization according to an embodiment, and FIG. 9 is a view illustrating another example of pipeline parallelization according to an embodiment.

Because it is assumed that the number of pipeline stages is set to be equal to the number of nodes in a cluster in an embodiment, the Pipeline Parallelism Degree (referred to as ‘Degree_PP’ hereinbelow) is equal to the number of nodes.

Referring to FIG. 6, the pipeline parallelizing module 120 divides the layers constituting a model into equal numbers and initially allocating the layers to the multiple nodes according to the node sequence at step S310.

Here, when the number of layers of the model is l and the number of nodes is m, the number of layers kᵢ distributed to the i-th node of the node sequence S may be calculated as shown in Equation (2) below:

$${k}_{0} = ⌈ \frac{l}{m} ⌉ , {k}_{i} = ⌈ \frac{l - {\sum }_{j = 0}^{i - 1} {k}_{j}}{m - i} ⌉ \qquad ( 2 )$$

For example, referring to FIGS. 7 and 9, an example of parallelizing a model having six layers in a cluster, including a node N1 in which eight GPUs, each having 10 GB of memory, are mounted and a node N2 in which eight GPUs, each having 20 GB of memory, are mounted is illustrated. Here, because the number of layers of the model is 6 and the number of nodes is 2, three layers are equally distributed to each of the nodes according to Equation (2) above.

However, in the example illustrated in FIG. 7, the memory requirement of pipeline stage 1 allocated to the first node N1 exceeds the total amount of GPU memory of the node. That is, when three layers requiring 40 GB, 20 GB, and 40 GB are allocated to the first node in the node sequence, the total amount of memory required for all of the allocated layers becomes 100 GB, which exceeds the total amount of memory of the node, 80 GB.

This is caused because the respective model layers may have different memory requirements and because the respective nodes in a heterogeneous GPU cluster according to an embodiment may have different amounts of GPU memory.

Accordingly, in an embodiment, when there is a node to which layers having a memory requirement greater than the total amount of GPU memory of the node are allocated, the pipeline parallelizing module 120 performs reallocating some layers of the corresponding node to another node at steps S320 to S390, as illustrated in FIG. 6.

That is, the pipeline parallelizing module 120 sequentially traverses the nodes according to the node sequence S and thereby checks at step S320 whether there is a node to which layer having a memory requirement that exceeds the total amount of GPU memory of the corresponding node are allocated.

When a node to which layers requiring memory greater than the total amount of GPU memory of the node are allocated is not found at step S320, the pipeline parallelizing module 120 determines that pipeline parallelization is completed and then terminates the operation.

That is, as shown in the example illustrated in FIG. 9, the memory requirement of pipeline stage 1 is 25 GB and does not exceed 80 GB, which is the total amount of GPU memory of the corresponding node, and the memory requirement of pipeline stage 2 is 30 GB and does not exceed 160 GB, which is the total amount of GPU memory of the corresponding node. Accordingly, all of the nodes satisfy the memory requirements of the model layers allocated thereto, so the operation is terminated.

Conversely, when a node to which layers requiring memory greater than the total amount of GPU memory of the node are allocated is found at step S320, the pipeline parallelizing module 120 determines the first found node s_j (0<=j<m−1) and initializes the variable p to 1 at step S330.

Here, the number of model layers allocated to the node s_j is k_j, and the respective layers are sequentially expressed as Layer_0, . . . , Layer_(k_j−1). Here, k_j may include the number of layers transferred to the current node from a node at the previous position in the node sequence due to the excess of the memory requirement.

The pipeline parallelizing module 120 compares the total amount of GPU memory (ΣMEM gpu) of the node with the memory requirement (Σᵢ₌₀^{k}^{_{−j}}^{-p} MEMLayer_i) of all of the layers allocated to the corresponding node at step S340.

Here, the memory requirement of a node that receives layers from a node at the previous position in the node sequence may be calculated by including the initially allocated layers and the received layers.

When it is determined at step S340 that the total amount of GPU memory of the node is less than the memory requirement of all of the layers allocated to the node, the pipeline parallelizing module 120 determines at step S350 whether the node s_j is the last node in the sequence S.

When it is determined at step S350, the node s_j is the last node in the sequence S, the pipeline parallelizing module 120 terminates the operation because the pipeline parallelization fails.

Conversely, when it is determined at step S350 that the node s_j is not the last node in the sequence S, the pipeline parallelizing module 120 increases p by 1 at step S360 and proceeds to step S340.

Meanwhile, when it is determined at step S340 that the total amount of GPU memory of the node is equal to or greater than the memory requirement of all of the layers allocated to the node, the pipeline parallelizing module 120 determines at step S370 whether p is greater than 1.

When it is determined at step S370 that p is equal to or less than 1, the pipeline parallelizing module 120 determines that there is no layer to transfer to the subsequent node and terminates the operation because the pipeline splitting is successfully completed.

Conversely, when it is determined at step S370 that p is greater than 1, the pipeline parallelizing module 120 determines that there are layers to transfer to the subsequent node, so transfers the layers from Layer_(k_j−1) to Layer_(k_j−p) to s_(j+1), which is the subsequent node, at step S380.

For example, the last layer requiring 40 GB of memory, which causes the total amount of GPU memory of the node of stage 1 illustrated in FIG. 7 to be exceeded, is transferred to the node at the subsequent position in the node sequence as illustrated in FIG. 8, whereby the memory requirements of all of the pipeline stages are satisfied.

Subsequently, the pipeline parallelizing module 120 increases the value of j by 1 and then proceeds to step S330.

Once the above-described pipeline parallelization task is successfully completed, the model is split for pipelines at the layer level and allocated to the respective nodes.

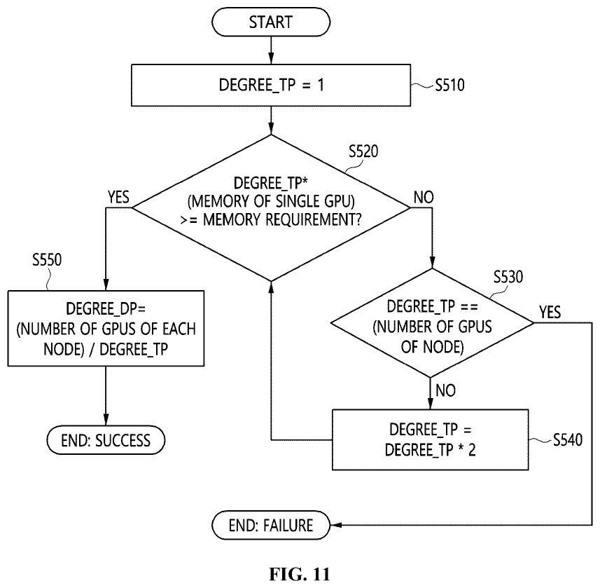

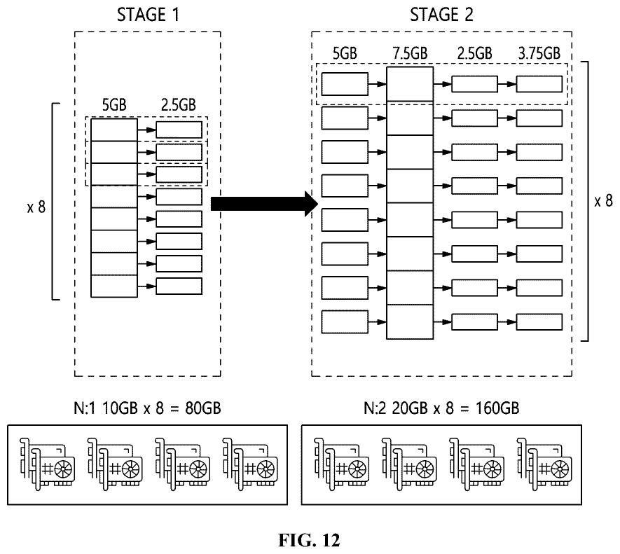

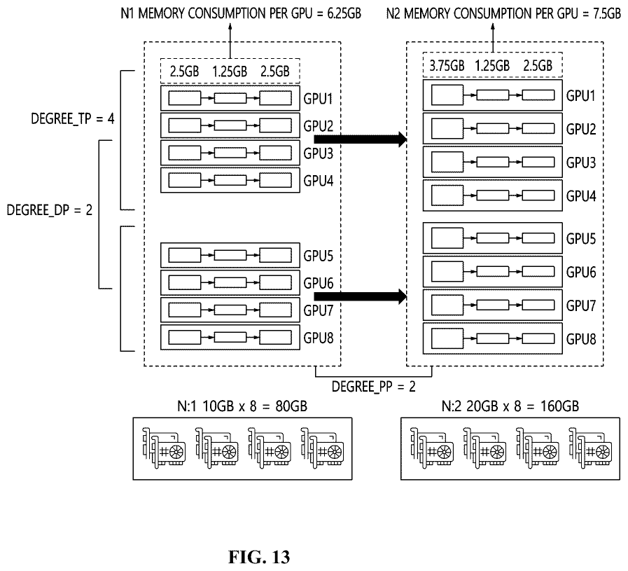

FIG. 10 is a flowchart for explaining the operation of a data/tensor parallelizing module according to an embodiment, FIG. 11 is a flowchart for explaining the operation of a data/tensor parallelizing module for each node according to an embodiment, FIG. 12 is a view illustrating an example of data/tensor parallelization according to an embodiment, and FIG. 13 is a view illustrating another example of data/tensor parallelization according to an embodiment.

Referring to FIG. 10, the data/tensor parallelizing module 130 initially calculates the tensor parallelism degree (referred to as the ‘Degree_TP’ hereinbelow) and the data parallelism degree (referred to as the ‘Degree_DP’ hereinbelow) in a node at step S410. Step S410 will be described in detail later with reference to FIG. 11.

Subsequently, the data/tensor parallelizing module 130 repeatedly performs step S410 for all multiple nodes at step S420 and aggregates the values initially calculated for the respective nodes, thereby determining the final Degree_TP and the final Degree_DP at step S430.

Referring to FIG. 11, the data/tensor parallelizing module 130 may perform calculating the Degree_TP based on the memory requirement of allocated model layers and the memory capacity of a single GPU at steps S510 to S540 and calculating the Degree_DP based on the calculated Degree_TP and the number of GPUs at step S550.

First, the data/tensor parallelizing module 130 initializes the Degree_TP to 1 at step S510.

Subsequently, the data/tensor parallelizing module 130 compares the memory size corresponding to a number of GPUs equal to the current Degree_TP with the amount of GPU memory required for the model layers allocated to the current node at step S520.

When it is determined at step S520 that a number of GPUs equal to the Degree_TP do not satisfy the amount of memory required for the model layers, the data/tensor parallelizing module 130 determines whether the Degree_TP is equal to the number of GPUs at step S530.

When it is determined at step S530 that the Degree_TP is equal to the number of GPUs, the data/tensor parallelizing module 130 determines the failure of parallelization and terminates the operation.

Conversely, when it is determined at step S530 that the Degree_TP is not equal to the number of GPUs, the data/tensor parallelizing module 130 doubles the Degree_TP and performs step S520 again.

Meanwhile, when it is determined at step S520 that a number of GPUs equal to the Degree_TP satisfy the amount of memory required for the model layers, the data/tensor parallelizing module 130 calculates the Degree_DP as shown in Equation (3) below and terminates the operation at step S550.

$$Degree\_DP = number of GPUs of each node / Degree\_TP \qquad ( 3 )$$

Meanwhile, when performing step S430 according to the embodiment illustrated in FIG. 10, the data/tensor parallelizing module 130 may perform setting the final Degree_TP to the maximum value of the Degree_TP values initially calculated for the respective nodes and setting the final Degree_DP to the Degree_DP of the node that has the final Degree_TP as the initial Degree_TP thereof.

That is, because the highest Degree_TP means that the tensor has to be split into as many chunks as possible due to the greatest memory burden, it is reasonable to set the Degree_TP and Degree_DP of the entire cluster based on the corresponding node.

For example, when tensor/data parallelization is performed in the nodes that are pipeline-parallelized as illustrated in FIG. 8, the same parallelization result is obtained for both N1 and N2 in the early stage (at step S410 of FIG. 10) as illustrated in FIG. 12 (Degree_DP=1, Degree_TP=8), and thus the following parallelization policy is finally determined (at step S430 of FIG. 10).
Degree_PP=2 (N1: Layers 0 and 1, N2: Layers 2, 3, 4, and 5)
Degree_DP=1 (data parallelization is not applied)
Degree_TP=8 (parallelization by splitting a tensor into eight chunks)

In another example, when tensor/data parallelization is performed in the nodes that are pipeline-parallelized as illustrated in FIG. 9, different parallelization results are obtained for N1 and N2 in the early stage (at step S410 of FIG. 10).

That is, because the memory requirement of N1 is 25 GB and the memory of a single GPU is 10 GB, the initial Degree_TP_stage1 is 4 and the initial Degree_DP_stage1 is 2.

Also, because the memory requirement of N2 is 30 GB and the memory of a single GPU is 20 GB, the initial Degree_TP_stage2 is 2 and the initial Degree_DP_stage2 is 4.

Based on the initial values that are different in the respective nodes, as described above, the following parallelization policy is finally determined (at step S430 of FIG. 10) as illustrated in FIG. 13.
Degree_PP=2
Degree_TP=max (Degree_TP_stage1, Degree_TP_stage2)=4
Degree_DP=8 (number of GPUs of each node)/Degree_TP=2

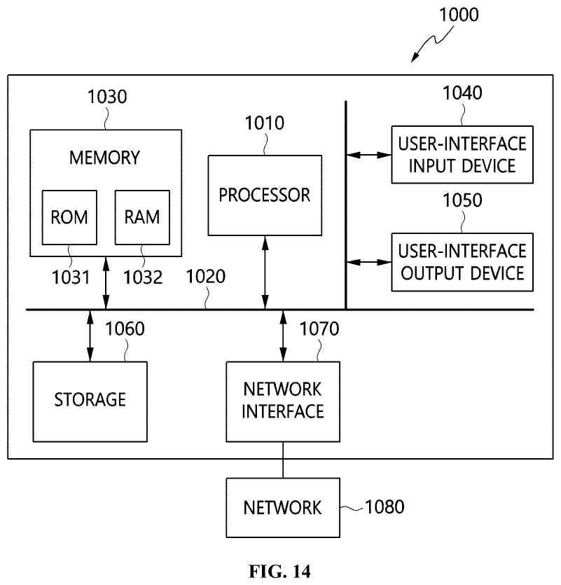

FIG. 14 is a view illustrating a computer system configuration according to an embodiment.

The apparatus for 3D parallelization for a heterogeneous GPU cluster according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

Also, a method for 3D parallelization for a heterogeneous GPU cluster may be performed by the apparatus 100 for 3D parallelization for a heterogeneous GPU cluster according to the above-described embodiment.

The method for 3D parallelization for a heterogeneous GPU cluster according to an embodiment may include generating initialization information based on GPU memory capacity in order to parallelize a model across multiple nodes constituting a heterogeneous GPU cluster, pipeline-parallelizing the model based on the multiple nodes using the generated initialization information, and data/tensor-parallelizing layers of the model, which are allocated to each of the multiple nodes according to the pipeline parallelization, based on GPUs mounted in the corresponding node.

Here, generating the initialization information may include arranging the multiple nodes based on the total amount of GPU memory, setting a node sequence in the order in which the multiple nodes are arranged, and calculating the amount of GPU memory required for each of the layers constituting the model.

Here, the node sequence may be the sequence of the nodes arranged in ascending order of the total amount of GPU memory.

Here, pipeline-parallelizing the model may include dividing the layers constituting the model into equal numbers and initially allocating the layers to the multiple nodes according to the node sequence, and when there is a node to which layers having a memory requirement greater than the total amount of GPU memory of the node are allocated, reallocating part of the layers of the corresponding node to another node. Here, reallocating the part of the layers may comprise transferring remaining layers, excluding layers having a memory requirement satisfied by the total amount of GPU memory of the corresponding node, to the node at the subsequent position in the node sequence.

Here, reallocating the part of the layers may comprise calculating the memory requirement of a node receiving layers from the node at the previous position in the node sequence by including the initially allocated layers and the received layers.

Here, data/tensor parallelizing the layers may include initially calculating a tensor parallelism degree and a data parallelism degree for each of the nodes and setting a final tensor parallelism degree and a final data parallelism degree by aggregating the values initially calculated for the respective nodes.

Here, initially calculating the tensor parallelism degree and the data parallelism degree may include calculating the tensor parallelism degree based on the memory requirement of the allocated model layers and the memory capacity of a single GPU and calculating the data parallelism degree based on the calculated tensor parallelism degree and the number of GPUs.

Here, setting the final tensor parallelism degree and the final data parallelism degree may include setting the final tensor parallelism degree to the maximum value of the tensor parallelism degrees initially calculated for the respective nodes and setting the final data parallelism degree to the initial data parallelism degree of the node that has the final tensor parallelism degree as the initial tensor parallelism degree thereof.

According to the disclosed embodiment, a 3D parallelization policy may be automatically determined for training and inference using a large model in a heterogeneous GPU cluster system where GPUs with different performance are mounted in respective nodes.

Therefore, without the burden of a user having to determine the parallelization policy of the model, the parallelization policy may be automatically determined by recognizing the hardware performance and model attributes. Also, the parallelization policy may be quickly determined because of the lower complexity compared to other automatic parallelism techniques.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for three-dimensional (3D) parallelization for a heterogeneous GPU cluster, comprising:
memory in which at least one program is recorded; and
a processor for executing the program,
wherein the program generates initialization information based on GPU memory capacity in order to parallelize a model across multiple nodes constituting a heterogeneous GPU cluster, pipeline-parallelizes the model based on the multiple nodes using the generated initialization information, and data/tensor-parallelizes layers of the model, which are allocated to each of the multiple nodes according to pipeline parallelization, based on GPUs mounted in the corresponding node.

2. The apparatus of claim 1, wherein
the multiple nodes include an equal number of GPUs mounted therein, and
the number of GPUs is a power of 2.

3. The apparatus of claim 1, wherein, when generating the initialization information, the program arranges the multiple nodes based on a total amount of GPU memory, sets a node sequence in an order in which the multiple nodes are arranged, and calculates an amount of GPU memory required for each of the layers constituting the model.

4. The apparatus of claim 3, wherein the node sequence is a sequence of the nodes arranged in ascending order of the total amount of GPU memory.

5. The apparatus of claim 4, wherein, when pipeline-parallelizing the model, the program divides the layers constituting the model into equal numbers and initially allocates the layers to the multiple nodes according to the node sequence, and when there is a node to which layers having a memory requirement greater than the total amount of GPU memory of the node are allocated, the program reallocates part of the layers of the corresponding node to another node.

6. The apparatus of claim 5, wherein, when reallocating the part of the layers, the program transfers remaining layers, excluding layers having a memory requirement satisfied by the total amount of GPU memory of the corresponding node, to a node at a subsequent position in the node sequence.

7. The apparatus of claim 6, wherein, when reallocating the part of the layers, the program calculates a memory requirement of a node receiving layers from a node at a previous position in the node sequence by including the initially allocated layers and the received layers.

8. The apparatus of claim 1, wherein, when data/tensor-parallelizing the layers, the program initially calculates a tensor parallelism degree and a data parallelism degree for each of the nodes and sets a final tensor parallelism degree and a final data parallelism degree by aggregating values initially calculated for the respective nodes.

9. The apparatus of claim 8, wherein, when initially calculating the tensor parallelism degree and the data parallelism degree, the program calculates the tensor parallelism degree based on a memory requirement of the allocated layers and memory capacity of a single GPU and calculates the data parallelism degree based on the calculated tensor parallelism degree and a number of GPUs.

10. The apparatus of claim 8, wherein, when setting the final tensor parallelism degree and the final data parallelism degree, the program sets the final tensor parallelism degree to a maximum value of the tensor parallelism degrees initially calculated for the respective nodes and sets the final data parallelism degree to an initial data parallelism degree of a node that has the final tensor parallelism degree as an initial tensor parallelism degree thereof.

11. A method for three-dimensional (3D) parallelization for a heterogeneous GPU cluster, comprising:
generating initialization information based on GPU memory capacity in order to parallelize a model across multiple nodes constituting a heterogeneous GPU cluster;
pipeline-parallelizing the model based on the multiple nodes using the generated initialization information; and
data/tensor-parallelizing layers of the model, which are allocated to each of the multiple nodes according to pipeline parallelization, based on GPUs mounted in the corresponding node.

12. The method of claim 11, wherein generating the initialization information includes
arranging the multiple nodes based on a total amount of GPU memory;
setting a node sequence in an order in which the multiple nodes are arranged; and
calculating an amount of GPU memory required for each of the layers constituting the model.

13. The method of claim 12, wherein the node sequence is a sequence of the nodes arranged in ascending order of the total amount of GPU memory.

14. The method of claim 13, wherein pipeline-parallelizing the model includes
dividing the layers constituting the model into equal numbers and initially allocating the layers to the multiple nodes according to the node sequence; and
when there is a node to which layers having a memory requirement greater than the total amount of GPU memory of the node are allocated, reallocating part of the layers of the corresponding node to another node.

15. The method of claim 14, wherein reallocating the part of the layers comprises transferring remaining layers, excluding layers having a memory requirement satisfied by the total amount of GPU memory of the corresponding node, to a node at a subsequent position in the node sequence.

16. The method of claim 15, wherein reallocating the part of the layers comprises calculating a memory requirement of a node receiving layers from a node at a previous position in the node sequence by including the initially allocated layers and the received layers.

17. The method of claim 11, wherein data/tensor-parallelizing the layers includes
initially calculating a tensor parallelism degree and a data parallelism degree for each of the nodes; and
setting a final tensor parallelism degree and a final data parallelism degree by aggregating values initially calculated for the respective nodes.

18. The method of claim 17, wherein initially calculating the tensor parallelism degree and the data parallelism degree includes
calculating the tensor parallelism degree based on a memory requirement of the allocated layers of the model and memory capacity of a single GPU; and
calculating the data parallelism degree based on the calculated tensor parallelism degree and a number of GPUs.

19. The method of claim 17, wherein setting the final tensor parallelism degree and the final data parallelism degree includes
setting the final tensor parallelism degree to a maximum value of the tensor parallelism degrees initially calculated for the respective nodes; and
setting the final data parallelism degree to an initial data parallelism degree of a node that has the final tensor parallelism degree as an initial tensor parallelism degree thereof.

20. A method for three-dimensional (3D) parallelization for a heterogeneous GPU cluster, comprising:
arranging multiple nodes in ascending order of a total amount of GPU memory;
setting a node sequence in an order in which the multiple nodes are arranged;
calculating an amount of GPU memory required for each of layers constituting a model;
dividing the layers constituting the model into equal numbers and initially allocating the layers to the multiple nodes according to the node sequence;
when there is a node to which layers having a memory requirement greater than a total amount of GPU memory of the node are allocated, reallocating part of the layers of the corresponding node to another node;
initially calculating a tensor parallelism degree and a data parallelism degree for each of the nodes; and
setting a final tensor parallelism degree and a final data parallelism degree by aggregating values initially calculated for the respective nodes.
